(19) United States
(12) Patent Application Publication
(10) Pub. No.: US 2018/0328373 A1
(43) Pub. Date: Nov. 15, 2018

(54) Turbocharger

(71) Applicant: MAN DIESEL & TURBO SE, Augsburg (DE)

(72) Inventors: Fikri Aynacioglu, Remscheid (DE); Stefan Mühlenbrock, Datteln (DE); Björn Hoßbach, Diedorf (DE); Klaus Hörmeyer, Düsseldorf (DE); Philipp Köster, Oberhausen (DE); Dirk Anding, Oberhausen (DE)

(73) Assignee: MAN DIESEL & TURBO SE

(21) Appl. No.: 15/971,779

(22) Filed: May 4, 2018

(30) Foreign Application Priority Data
May 15, 2017 (DE) 102017208107.4

(51) Int. Cl. F04D 29/02; F01D 25/24; F04D 17/10; F04D 29/053; F04D 29/056

(52) U.S. Cl. CPC F04D 29/023; F01D 25/24; F04D 17/10; F01D 5/043; F04D 29/056; F05D 2300/17; F05D 2220/40; F04D 29/053

(57) ABSTRACT

A turbocharger, with a turbine for expanding a first medium and a compressor for compressing a second medium utilising energy extracted in the turbine during the expansion of the first medium. The turbine has a turbine housing and a turbine rotor. The compressor has a compressor housing and a compressor rotor coupled to the turbine rotor via a shaft. The turbine housing and the compressor housing are each connected to a bearing housing in which the shaft is mounted. The bearing housing is connected to a turbine inflow housing of the turbine housing via a compensation element.

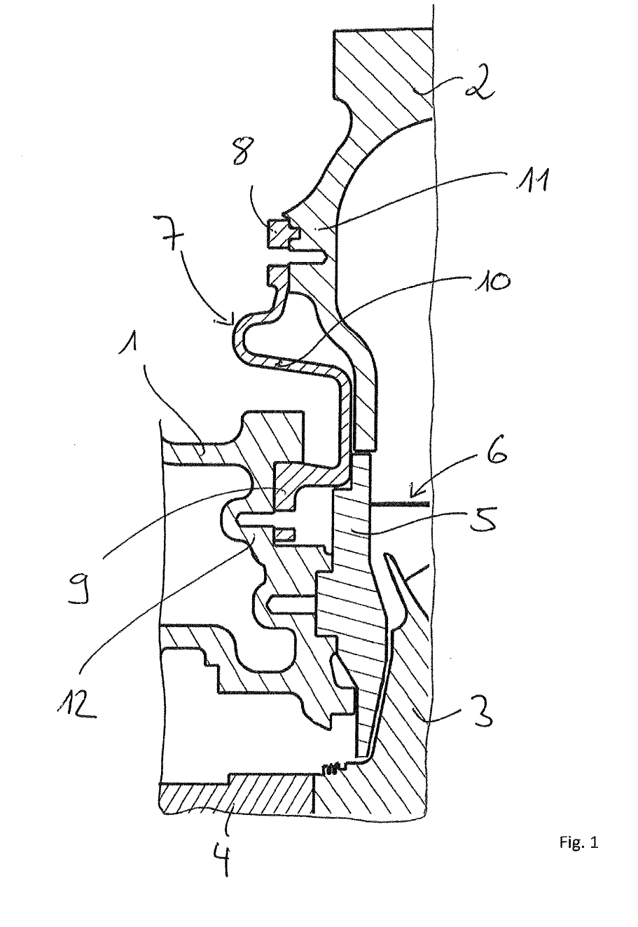

### BACKGROUND OF THE INVENTION

### 1. Field of the Invention

The invention relates to a turbocharger.

### 2. Description of the Related Art

A turbocharger comprises a turbine and a compressor. In the turbine a first medium, in particular exhaust gas, is expanded and energy extracted in the process. In the compressor a second medium, in particular charge air, is compressed namely utilising the energy extracted in the turbine during the expansion of the first medium. The turbine of a turbocharger comprises a turbine housing and a turbine rotor. The compressor of the turbine rotor and compressor rotor are coupled via a shaft mounted in a bearing housing, wherein the bearing housing is connected to the turbine housing and to the compressor housing.

From practice it is known that the turbine housing acomprises a turbine inflow housing via which the medium to be expanded can be fed to the turbine rotor. The turbine housing typically receives an insert piece and a nozzle ring of the turbine housing. By way of the insert piece, the expanded first medium can be discharged from the turbine. The insert piece extends radially to the outside adjacent to moving blades of the turbine rotor. The nozzle ring, which is also described as a turbine guide apparatus, guide grille, or guide apparatus, comprises guide blades, which seen in the flow direction of the first medium, are positioned upstream of the turbine rotor, and via which the first medium to be expanded is guided upstream of the turbine rotor.

In turbochargers known from practice, the turbine inflow housing is typically connected to the bearing housing via a clamping claw connection. Such a connection of the turbine inflow housing to the bearing housing must be rated critically because of its design, since between the turbine inflow housing and the bearing housing there are typically high temperature differences. Accordingly, the turbine inflow housing is exposed to the relatively high exhaust gas and accordingly subject to higher thermal load in the bearing housing. Because of this, temperature-induced deformations in the connecting region between turbine inflow housing and bearing housing can occur that negatively affect the tightness of the clamping claw connection between turbine inflow housing and bearing housing. There is a need in this regard to better attach the turbine inflow housing on the bearing housing.

### SUMMARY OF THE INVENTION

One aspect of the present invention is based on creating a new type of turbocharger. According to one aspect of the invention, the bearing housing is connected to the turbine inflow housing of the turbine housing via a compensation element. By way of the compensation element, temperature-induced deformations in the connecting region between turbine inflow housing and bearing housing can be offset. In the radial direction, the compensation element is flexible and elastic so that the same can perform a radial expansion and accordingly absorb or offset a temperature-induced displacement between turbine inflow housing and bearing housing.

Preferentially, the compensation element is connected to the turbine inflow housing at a radially outer section and to the bearing housing at a radially inner section, wherein seen in the radial direction a wall contoured in the manner of a bellows section or with a bent profile extends between these sections. Such a configuration and connection of the compensation element to the turbine inflow housing and bearing housing is particularly preferred.

According to a further development of the invention, the compensation element comprising of a nickel-based alloy material. Particularly preferably, the nickel-based alloy material has the following composition in per cent by weight: 50.00-55.00% nickel (NI), 17.00-21.00% chromium (Cr), 4.75-5.50% niobium (Nb), 2.80-3.30% molybdenum (Mo), 0.65-1.15% titanium (Ti), 0.20-0.80% aluminium (Al), iron (Fe) in the remainder. Such a material for the compensation element provides an adequately high creep resistance for the compensation element even at temperatures of more than 600° C. Turbine inflow housing and bearing housing can be produced from metallic materials such as the same are usual in turbochargers known from practice.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

The Figure is a cross section by way of an extract in axial direction through a turbocharger in a region of a turbine and of a bearing housing.

### DETAILED DESCRIPTION OF THE PRESENTLY PREFERRED EMBODIMENTS

The invention relates to a turbocharger. A turbocharger comprises a turbine for expanding a first medium, in particular for expanding exhaust gas of an internal combustion engine. Furthermore, a turbocharger comprises a compressor for compressing a second medium, in particular charge air, namely utilising energy extracted in the turbine during the expansion of the first medium. Here, the turbine comprises a turbine housing and a turbine rotor. The compressor comprises a compressor housing and a compressor rotor. The compressor rotor is coupled to the turbine rotor via a shaft which is mounted in a bearing housing, wherein the bearing housing is positioned between the turbine housing and the compressor housing and is connected to both the turbine housing and the compressor housing.

The person skilled in the art addressed here is familiar with the above fundamental construction of a turbocharger.

The Figure shows a portion of a turbocharger according to one aspect of the invention in a region of the connection between the bearing housing 1 and a turbine inflow housing 2 of the turbine housing of a turbine. The Figure furthermore, shows by way of a portion of a turbine rotor 3 and a shaft 4, wherein the turbine rotor 3 is coupled to a compressor rotor that is not shown via the shaft 4. The bearing housing 2 includes a bearing housing cover 5 connected to the bearing housing 1 and seen in the axial direction is positioned in sections between the turbine rotor 3 and the bearing housing 1.

The turbine inflow housing 2 feeds the first medium to be expanded to the turbine rotor 3. As seen in the flow direction of the first medium to be expanded, a so-called nozzle ring 6 is positioned upstream of the turbine rotor 3, which nozzle ring 6 is also described as turbine guide apparatus. The medium to be fed to the turbine rotor 3 is guided upstream of the turbine rotor 3 via the nozzle ring 6, specifically via guide blades of the nozzle ring 6.

One aspect of the present invention provides an entirely new type of connection of the turbine inflow housing 2 to the bearing housing 1, namely via a compensation element 7. Accordingly, bearing housing 1 and turbine inflow housing 2 are connected to one another via the compensation element 7. The compensation element is flexible and elastic in the radial direction in order to offset a temperature-induced distinct thermal deformation of bearing housing 1 and turbine inflow housing 2. By way of its elasticity, the compensation elements 7 can offset a temperature-induced radial expansion.

The compensation element 7 is mounted to the turbine inflow housing 2 with a radially outer section 8 of the compensation element 7 and connected to the bearing housing with a radially inner section 9 of the same. Typically, a screw connection between the compensation element 7 and the turbine inflow housing 2 and bearing housing is provided here in each case.

Between the two sections 8, 9 of the compensation element 7, the same comprises a wall, which seen in the radial direction, is contoured in the manner of a bellows section or follows a bent course. This wall 10 is deformable in the manner of a bellows or concertina-like to offset temperature-induced radial expansions.

The two sections 8, 9 of the compensation element 7 are arranged, seen in the axial direction, approximately in the same axial position. Seen in the radial direction however there is a clear offset between the sections 8, 9, wherein the wall contoured in the manner of a bellows section or following a bent course partly extends in the radial direction and partly in the axial direction with bent sections in between.

Seen in flow direction of the first medium to be expanded, the section 8 of the compensation element 7 acts on a section 11 of the turbine inflow housing 2, which is positioned upstream of the nozzle ring 6. A section 12 of the bearing housing 1, on which the section 9 of the compensation element 7 acts, is positioned, seen in the radial direction, approximately at the radial height of the nozzle ring 6.

The compensation element 7 is produced from a nickel-based alloy material.

Preferentially, the nickel-based alloy material has the following composition in per cent by weight: 50.00-55.00% nickel (Ni), 17.00-21.00% chromium (Cr), 4.75-5.50% niobium (Nb), 2.80-3.30% molybdenum (Mo), 0.65-1.15% titanium (Ti), cobalt, carbon, magnesium, silicon, phosphorus, sulphur, boron, copper, iron (Fe) in the remainder.

| | |
|---|---|
| 50.00-55.00% | Nickel (Ni) |
| 17.00-21.00% | Chromium (Ci) |
| 4.75-5.50% | Niobium (Nb) |
| 2.80-3.30% | Molybdenum (Mo) |
| 0.65-1.15% | Titanium (Ti) |
| 0.20-0.80% | Aluminium (Al) |
| 0.00 to 1.00% | Cobalt (Co) |
| 0.00 to 0.08% | Carbon (C) |
| 0.00 to 0.35% | Magnesium (Mg) |
| 0.00 to 0.35% | Silicon (Si) |
| 0.00 to 0.015% | Phosphorus(P) |
| 0.00 to 0.017% | Sulphur (S) |
| 0.00 to 0.006% | Boron (B) |
| 0.00 to 0.30% | Copper(Cu) |
| in the remainder | Iron (Fe) |

Such a nickel-based alloy material has a good creep resistance even at temperatures of more than 600° C., so that a temperature-induced failure of the compensation element 7 is not expected.

The compensation element 7 does not only serve for compensating for temperature-induced radial expansions in the connecting region between bearing housing 1 and turbine inflow housing 2, on the contrary, the containment safety of the turbocharger can also be improved via the same. Should the turbine rotor 3 burst, kinetic energy of fragments can also be intercepted via the compensation element 7.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbocharger, comprising
a turbine for expanding a first medium comprising:
a turbine housing
a turbine inflow housing of the turbine housing; and
a turbine rotor;
a shaft;
a compressor for compressing a second medium utilising energy extracted in the turbine during expansion of the first medium, comprising
a compressor housing; and
a compressor rotor coupled to the turbine rotor via the shaft;
a bearing housing arranged between the turbine housing and the compressor housing and to which the turbine housing and the compressor housing are each connected, and in which the shaft is mounted; and
a compensation element that connects the bearing housing to the turbine inflow housing of the turbine housing.

2. The turbocharger according to claim 1, wherein the compensation element is connected to the turbine inflow housing at a radially outer section.

3. The turbocharger according to claim 1, wherein the compensation element is connected to the bearing housing at a radially inner section.

4. The turbocharger according to claim 1, wherein the compensation element seen in a radial direction, comprises a wall that is one of:
contoured in a manner of a bellows section and
follows a bent course.

5. The turbocharger according to claim 1, further comprising:
a bearing housing cover connected to the bearing housing.

6. The turbocharger according to claim 1, wherein the compensation element comprises a nickel-based alloy material.

7. The turbocharger according to claim 6, wherein the nickel-based alloy material has a composition in per cent by weight:
50.00-55.00% nickel (NI),
17.00-21.00% chromium (Cr),
4.75-5.50% niobium (Nb),
2.80-3.30% molybdenum (Mo),
0.65-1.15% titanium (Ti),
0.20-0.80% aluminium (Al), and
iron (Fe) in a remainder.

8. The turbocharger according to claim 7, wherein the nickel-based alloy material comprises:
maximally 1.00% cobalt (Co),
maximally 0.08% carbon (C),
maximally 0.35% magnesium (Mg),
maximally 0.35% silicon (Si),
maximally 0.015% phosphorus (P),
maximally 0.017% sulphur (S),
maximally 0.006% boron (B), and
maximally 0.30% copper (Cu).

9. The turbocharger according to claim 1, wherein the turbine is a radial turbine.
